(19) United States
(12) Patent Application Publication
(10) Pub. No.: US 2026/0237012 A1
(43) Pub. Date: Aug. 13, 2026

(54) SYSTEM AND METHOD FOR RAPID ASSESSMENT AND COLLABORATIVE RESPONSE

(71) Applicant: Ugochukwu Chigoziem Ikpeazu, Fintas Al Ahmadi (KW)

(72) Inventor: Ugochukwu Chigoziem Ikpeazu, Fintas Al Ahmadi (KW)

(73) Assignee: Ugochukwu Chigoziem Ikpeazu, Abuja (NG)

(21) Appl. No.: 19/458,855

(22) Filed: Jan. 25, 2026

(30) Foreign Application Priority Data
Feb. 12, 2025 (NG) NG/P/2025/31

(51) Int. Cl. G06Q 50/26; G06N 3/092; G16Y 20/10

(52) U.S. Cl. CPC G06Q 50/265; G06N 3/092; G16Y 20/10

(57) ABSTRACT

A system and method for Rapid Assessment and Collaborative Response (RACR) are disclosed. The invention integrates distributed IoT sensor nodes with an AI-based assessment engine and a permissioned ledger to enable real-time detection, classification, resource assignment, and verifiable audit tracking across multiple stakeholders. The system orchestrates automated, role-specific response directives and records all communications and decisions in a tamper-evident ledger, thereby improving speed, coordination, accuracy, and accountability in emergency response scenarios.

### CROSS REFERENCE TO RELATED APPLICATION

“This application claims priority to Nigerian Patent Application No. NG/P/2025/31, filed Feb. 12, 2025.”

### FEDERALLY SPONSORED RESEARCH AND DEVELOPMENT

“Not Applicable”

### JOINT RESEARCH AGREEMENT

“Not Applicable”

### INCORPORATION-BY-REFERENCE OF MATERIAL SUBMITTED “Not Applicable”

### STATEMENT REGARDING PRIOR DISCLOSURE BY THE INVENTOR

“Not Applicable”

### INVENTED BY UGOCHUKWU CHIGOZIEM IKPEAZU

### FIELD OF THE INVENTION

The present invention relates generally to intelligent emergency response and public safety systems. More specifically, the invention concerns IoT-enabled systems and methods for real-time detection, classification, and coordinated response to incidents across multiple stakeholders, incorporating distributed sensor networks, AI decision modules, and secure ledgered audit trails.

### BACKGROUND OF THE INVENTION

Emergency management (also known as disaster management or emergency preparedness) is a discipline and system devoted to reducing vulnerability to hazards and effectively responding to disasters. Emergency management includes managing minor emergencies such as isolated incidents easily handled through day-to-day community functions, as well as managing disasters, which are events that exceed a community's inherent capacity to respond. Effective emergency and disaster management typically involves collaboration among individuals, organizations, and multiple levels of government, coordinated through a framework of preparedness, response, mitigation, and recovery activities. Globally, the terminology and emphasis may vary, with related concepts including disaster risk reduction and prevention, yet the underlying objective remains to prevent disasters where possible and to reduce their adverse impacts when they occur.

Various nations, businesses and international organizations have developed automated and semi-automated systems to enhance emergency response effectiveness. For example, ERA-GLONASS, the modern Russian emergency response system, operates using the GLONASS satellite network to automatically report vehicle collisions and location information. Since 2018, the Russian Federation has adhered to UNECE Regulation 144, which defines standards for Accident Emergency Call Components (AECC), Accident Emergency Call Devices (AECD), and Accident Emergency Call Systems (AECS).

Within the European Union, the eCall initiative was launched in 2001 to provide rapid assistance to motorists involved in collisions. eCall-equipped vehicles automatically transmit a 112-emergency call containing a minimal data set including vehicle coordinates through the GSM network to the nearest Public Safety Answering Point (PSAP). Although not intended for vehicle tracking, this automatic alert system dramatically reduces response time in life-threatening crashes. Legislative proposals predicted full EU-wide adoption by 2015, later extended to 2017-2018 due to procedural delays. Since 2018, the European Union has also been a member of UNECE Regulation 144, harmonizing standards for AECC, AECD, and AECS systems.

In the United States, major initiatives have aimed to modernize public safety communications. Since 2001, Project E911 has worked to associate automatic location data with calls to the 9-1-1 network. Building on that foundation, the Next Generation 9-1-1 (NG-911) initiative, introduced in 2006, expanded emergency call capability beyond voice to include digital and data transmissions. The goal was to enable any emergency caller or automated device to connect using diverse communication means, providing location and sensor data directly to the emergency operator. Tested successfully in 2010 and further developed under the National 911 Program (managed by the U.S. Department of Transportation's National Highway Traffic Safety Administration), NG-911 seeks to transition the emergency infrastructure toward fully digital, data-centric operation.

At the state level, the United States has also implemented innovative, domain-specific response systems. Examples include Georgia's Peer2Peer Warm Lines, which connect individuals facing challenges with trained specialists; Oklahoma's deployment of first-responder tablets equipped with crisis de-escalation tools; and Florida's integrated mental-health crisis response framework, offering remote treatment, substance abuse services, and childcare coordination. Together, these illustrate a broader movement toward technologically augmented emergency response at both federal and local levels.

Despite these advances, modern emergency response still relies heavily on human-initiated reporting (such as 9-1-1 calls) and manually coordinated dispatch systems. Situational awareness is typically generated from fragmented sources manual reports, isolated surveillance cameras, or agency-specific dispatch software each optimized for single-domain operation rather than cross-agency interoperability. These systems often suffer from latency, inconsistent data validation, and limited automation, resulting in slower detection, higher false-alarm rates, and inefficient resource allocation during time-critical incidents.

Between 2015 and 2017, researchers and technology vendors began introducing partial solutions to these limitations through innovations such as IoT sensors and smart cameras for automated detection, AI-driven data-fusion engines for event classification, and distributed ledger technologies (blockchain) for secure and verifiable data sharing. Corporate patent filings and academic research show rapid technical progress in these components individually; however, most solutions remain isolated in scope, addressing only device-level recording, server-side triage, or data authentication without establishing a cohesive, end-to-end framework that seamlessly connects multi-sensor fusion, AI-driven assessment, and multi-stakeholder coordination.

Concurrently, initiatives like Next Generation 9-1-1 (NG-911) have begun defining interfaces for ingesting non-voice data into public safety networks such as images, telemetry, or IoT alerts making the integration of sensor-based systems technically feasible, though still operationally immature. Many existing commercial emergency response platforms and integrated dispatch suites facilitate ingestion and communication but depend on centralized servers and manual decision-making for final task assignment, limiting scalability and real-time adaptability.

In view of these developments, examiners and prior-art reviewers typically regard simple combinations of existing technologies (IoT+AI+ledger) as obvious unless they yield demonstrable technical advantages. For example, a novel system must show concrete performance improvements such as lower latency, higher throughput, hierarchical fault tolerance, or smart-contract logic enabling autonomous, verifiable resource allocation. Thus, a continuing need exists for a system that not only collects and authenticates multi-source IoT data but also performs real-time automated assessment (including confidence scoring and contextual correlation), translates outputs into stakeholder-specific, prioritized actions, and records each step in an immutable, auditable ledger.

The present invention: system and method for Rapid Assessment and Collaborative Response (RACR), directly addresses this need. RACR unifies distributed IoT sensing, AI-based event classification, hierarchical orchestration, and permissioned ledger auditing into one integrated architecture. It enables near real-time detection, triage, and verified multi-stakeholder collaboration with measurable improvements in speed, accuracy, accountability, and resilience, significantly advancing the state of emergency management technology beyond the limitations of prior art systems.

### RELEVANT PRIOR ART AND DISTINGUISHING FEATURES

A number of prior patents and published applications relate to blockchain-enabled IoT systems, emergency-response architectures, and AI-assisted decision-making frameworks. These references demonstrate the rapid evolution of the field but also highlight the technical distinctions and inventive contributions of the present RACR system.

U.S. Pat. No. 10,789,590 B2 (IBM), titled “IoT Device with Blockchain Features,” discloses IoT devices that directly interact with blockchain smart contracts for device authentication, event recording, and automated token or contract interactions at the device level. This art is relevant to the RACR system's use of ledgering and device authentication; however, RACR extends beyond device-level interaction to encompass system-level orchestration, multi-sensor fusion, centralized AI assessment, stakeholder-specific task generation, and hierarchical node privileges aspects not taught in the IBM disclosure.

U.S. Pat. No. 10,595,183 B2 (Motorola Solutions), “Distributed Emergency Response System,” is notable for its multi-node communication framework and coordination of emergency data. The RACR system, however, introduces an additional layer of automation, wherein classification and response recommendations are produced through multi-modal AI, published to a tamper-evident distributed ledger, and executed through parent/sub-node privileges and smart-contract triggers. The combination of AI-based orchestration with hierarchical network governance differentiates RACR from the Motorola reference.

U.S. Pat. No. 11,395,124 B2 (AT&T), “Artificial Intelligence for Emergency Assistance,” provides a detailed disclosure of AI and data-fusion techniques for emergency call centers, capable of processing audio, visual, and text data to produce routing and triage suggestions. While this overlaps conceptually with RACR's classification engine, the present system distinguishes itself through its multi-modal fusion pipeline combining edge preprocessing, ensemble classification, and confidence scoring and by publishing the resulting assessment outputs directly to a distributed ledger. This immediate ledger publication enables automated, verifiable resource allocation triggered by smart contracts, supported by measurable technical metrics such as latency and confidence thresholds.

U.S. Patent Application Publication No. 2017/0232300A1, “Smart Camera/IoT Device with Blockchain Reporting,” describes cameras that report detected events to a blockchain, representing prior art relevant to the sensor-to-ledger pathway. In contrast, RACR extends this concept to an integrated, hierarchical network of sensors coordinated by an AI assessment engine that produces stakeholder-specific recommendations. In RACR, the ledger publication step is explicitly linked to downstream, automated, multi-stakeholder actions, a clear functional advancement beyond single-device reporting.

International Publication No. WO 2018/126029 A2, “Blockchains for Securing IoT Devices,” represents a broad PCT family covering trusted execution environments, root-of-trust chaining, and ledger histories for IoT networks. These disclosures reinforce the general framework for IoT security and ledger-based authentication. RACR, however, implements a higher-order functional pipeline encompassing detection, classification, confidence scoring, ledger publication, and smart-contract-based orchestration among multiple actors. Furthermore, RACR's design may employ specific ledger architectures or permission models optimized for public safety operations.

U.S. Patent Application Publication No. 2019/0372834 A1, “Blockchain-Based Device Management,” discloses orchestration, selective data restore, and migration mechanisms for IoT device ecosystems. This prior art is relevant to RACR's device lifecycle management and auditability components. Nonetheless, RACR differentiates itself through its real-time assessment and action mapping loop, wherein AI-generated classifications dynamically trigger coordinated emergency response activities a substantive leap from static device management to fully automated emergency orchestration.

Additionally, several Intrado and commercial emergency network patents (including those held by Everbridge and Motorola) cover aspects of integrated emergency call routing, alert dissemination, and severity classification. These references illustrate established practices in multi-agency coordination. However, RACR's novelty lies in its fusion of secure, tamper-evident ledgering with AI-derived, stakeholder-specific action recommendations, all governed by a hierarchical parent/sub-node topology that enables fault tolerance, resilience, and priority escalation. A unique combination not evident in any single piece of prior art.
Collectively, these prior references frame the technical landscape within which RACR operates, while underscoring its inventive step the unification of multi-modal AI fusion, secure distributed ledgering, and hierarchical orchestration into a cohesive, automated, and verifiable emergency response system.

### SUMMARY OF THE INVENTION

The present invention, the Rapid Assessment and Collaborative Response (RACR) system, provides an integrated, IoT-centric architecture that detects, classifies, and coordinates emergency or abnormal events through an intelligent, distributed framework. The system leverages a network of IoT nodes (102) that capture sensor data in real time, a gateway (104) that authenticates and aggregates the data, and a command server (106) that hosts an AI assessment module (108) and orchestration logic (110) for automated, data-driven response coordination. Verified incident information and actions are recorded within a permissioned blockchain ledger (112) to ensure auditability, accountability, and tamper-resistant inter-agency collaboration.

In one embodiment, the RACR platform reduces end-to-end incident-to-response latency by automating classification, prioritization, and resource allocation through smart-contract-driven policy workflows. Edge-based preprocessing at IoT nodes filters and compresses data to improve speed and bandwidth efficiency. The gateway normalizes metadata and enforces authentication, while the AI assessment engine produces an incident type, severity score, and confidence level. The orchestration layer maps these outcomes to stakeholder-specific response policies, executing smart contracts or other pre-configured triggers that automatically notify or deploy appropriate responders.

RACR provides measurable technical advantages: (1) reduced latency through local preprocessing and autonomous policy mapping; (2) higher accuracy and reduced false positives through multi-modal AI fusion; (3) secure, tamper-evident audit trails through blockchain ledgering; and (4) fault-tolerant operation using hierarchical parent and child node configurations (118, 120) that preserve network resilience even under partial failure.

### BRIEF DESCRIPTION OF THE DRAWINGS

FIG. 1 illustrates the overall RACR system architecture, showing IoT sensor nodes (102), gateway (104), command server (106) with AI assessment module (108), orchestration engine (110), ledger module (112), and user interface components (114).

FIG. 2 shows the layered architecture pattern of RACR, including the user application layer (102), interface layer (104), business application layer (106) and blockchain layer (114), and IoT communication layer.

FIG. 3 depicts the operational workflow, including data input (116), identity management (118), classification (120), alarm generation (122), alert (124), and subsequent actions (126) assigned, implemented, and completed across network nodes.

FIG. 4 presents a process-flow diagram showing how AI algorithms analyze sensor data from cameras and IoT devices (130), generate insights and distribute verified reports to multiple stakeholders (128) through the ledger network.

FIG. 5 illustrates the field-user-to-distributed-network communication flow, connecting a field user interface to sub-nodes and parent nodes within the RACR ecosystem (118, 120, 126, 130).

FIG. 6 shows multi-directional communication between parent and sub-nodes, highlighting the multidirectional data exchange and synchronization features that sustain coordinated operations.

FIG. 7 details the parent-and-child node configuration, demonstrating hierarchical authority and task propagation through the RACR network (118, 120).

FIG. 8 shows an example of report lifecycle and approval flow, from AI model processing and initial report generation to validation, task assignment, and final approval (122).

### DETAILED DESCRIPTION OF THE DRAWINGS

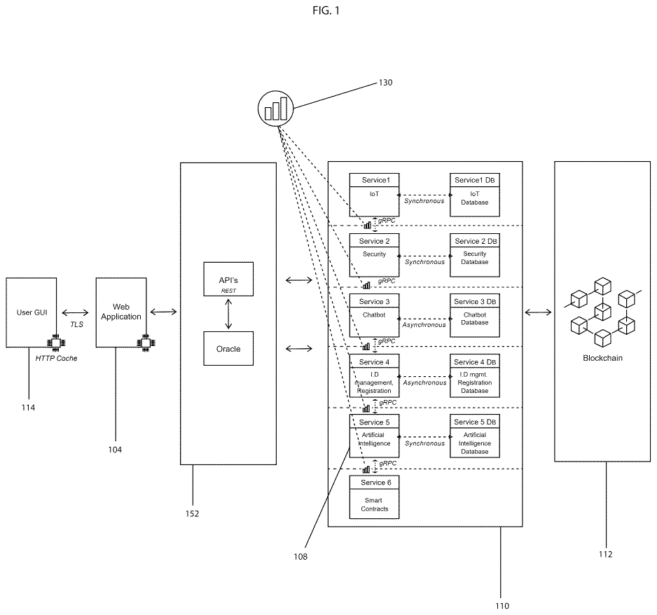

Referring to FIG. 1, the RACR system comprises a plurality of IoT sensor nodes (102) distributed across target environments. Each node includes one or more environmental or situational sensors, a local processor, and a secure communication module for transmitting data to a gateway (104). The gateway aggregates multi-source data, authenticates nodes, and normalizes metadata such as timestamps and geo-location before passing information to the command server (106). The command server hosts an AI assessment module (108) that applies trained machine-learning models to classify incident type, severity, and priority. An orchestration engine (110) interprets AI output and triggers stakeholder-specific actions according to predefined smart-contract rules. A blockchain ledger (112) immutably records events, classifications, and confirmations for audit and collaboration across agencies. User interfaces (114) enable responders to view incidents, update task status, and provide feedback.

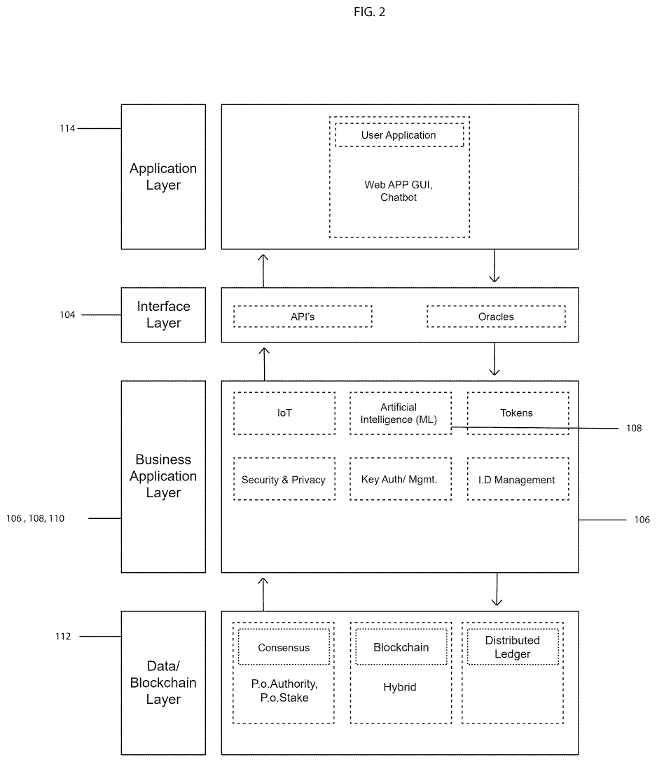

Referring to FIG. 2, the RACR platform reveals a layered architecture pattern comprising a user application layer (102), an interface layer (104) containing APIs and oracles, a business application layer (106) containing AI, orchestration, and policy modules, and a data/blockchain layer (114) implementing the distributed ledger for secure transaction storage.

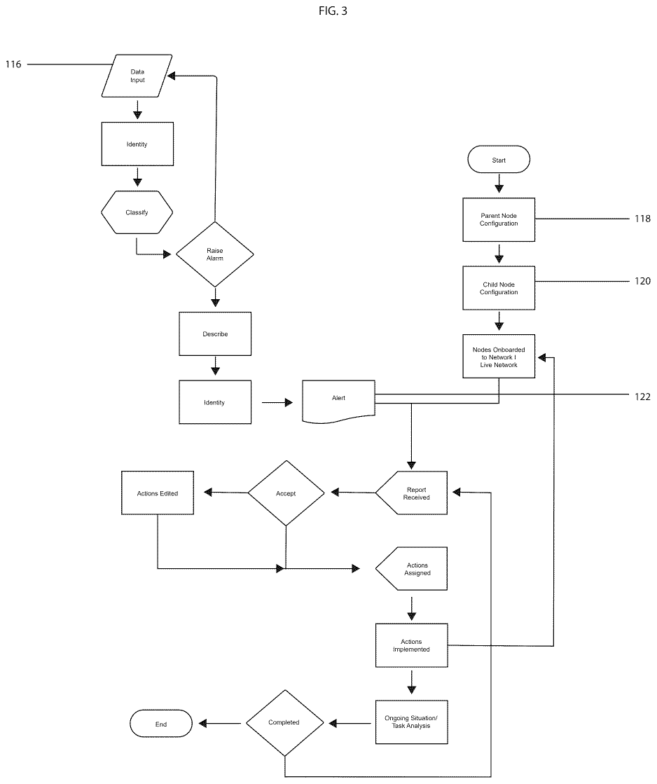

Referring to FIG. 3, RACR's workflow begins with data input (116) from field devices, followed by identity verification (118), classification (120), and alert generation (122). Subsequent modules handle action assignment (126), implementation, and final feedback recording. This workflow ensures that every event passes through a verified detection-classification-response-audit cycle.

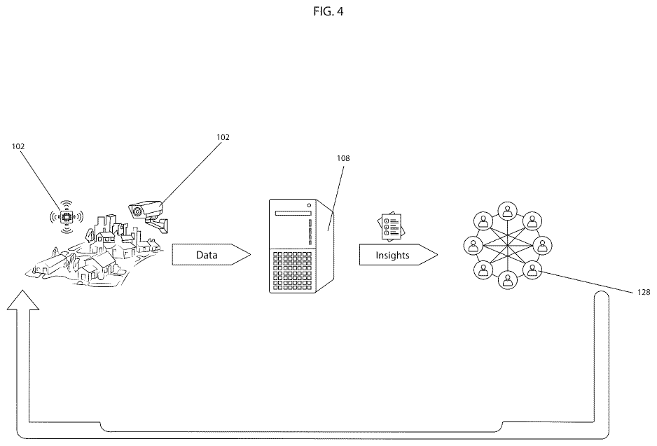

Referring to FIG. 4, IoT sensors (130) at the scene of an incident capture real-time environmental and visual data. AI algorithms process this data, generating incident classifications and recommended actions that are published as reports and insights (122) on the ledger. Stakeholders receive these reports via the distributed ledger network, enabling simultaneous, multi-agency action and coordination.

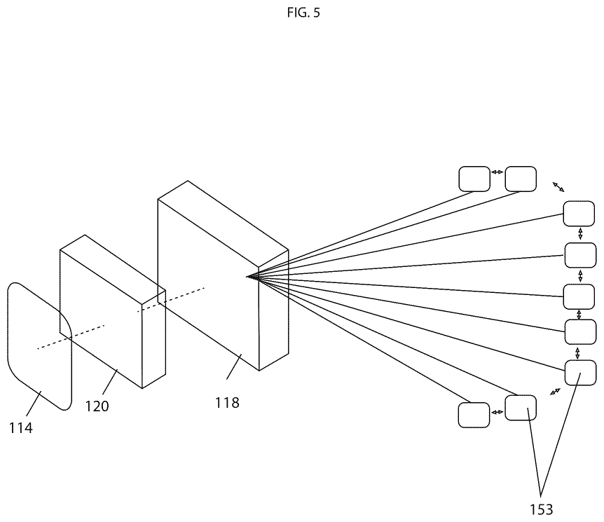

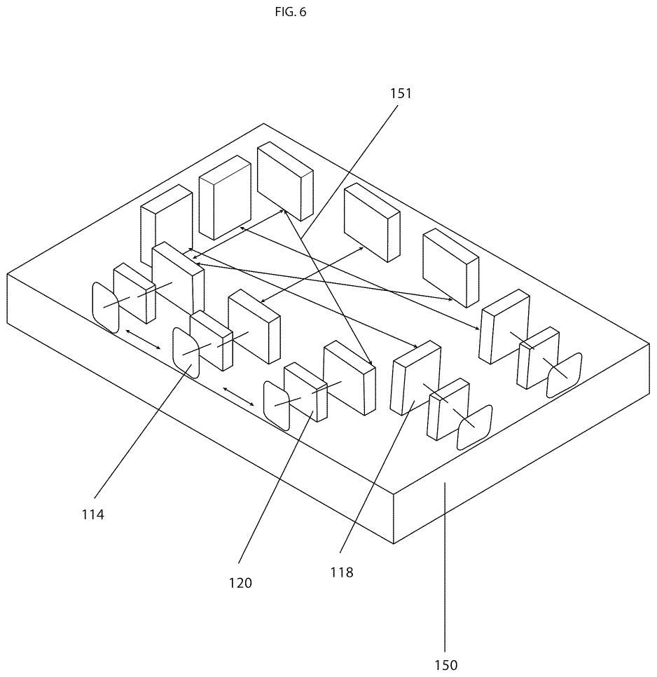

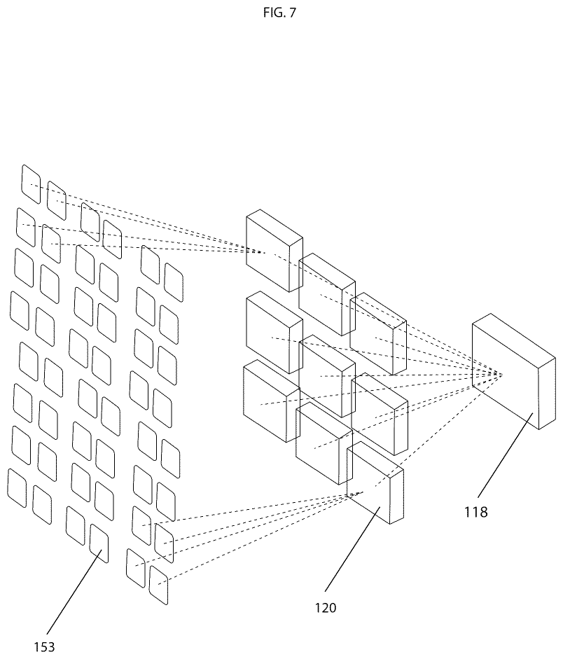

Referring to FIG. 5, a field user interacts with the RACR interface, transmitting observations or status updates to the distributed network of parent and child nodes (118, 120, 126, 130). FIG. 6 illustrates bidirectional communication between these nodes, while FIG. 7 focuses on the hierarchical configuration, ensuring continuity and authority alignment during incident handling.

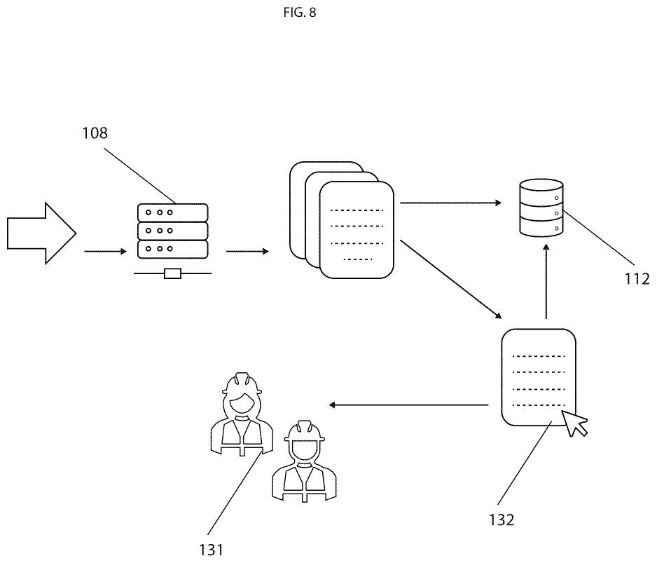

Referring finally to FIG. 8, an example report lifecycle is shown in which data input from sensors triggers AI model processing, report generation, review, and final approval (122). Approved reports are automatically distributed as structured task lists to relevant field users, closing the loop of detection, assessment, and verified response.

1. A system for rapid assessment and collaborative response, comprising:
I. a plurality of IoT sensor nodes configured to monitor environmental or situational parameters and to transmit sensor data;
II. a data gateway configured to receive said sensor data from the plurality of IoT sensor nodes, to authenticate and correlate the sensor data, and to forward aggregated data;
III. a command server communicatively coupled to the data gateway;
IV. an AI assessment module executed on the command server, configured to analyze the aggregated sensor data using a trained machine-learning model to generate an incident classification, a severity score, and a confidence metric;
V. an orchestration engine coupled to the AI assessment module, configured to map the incident classification and severity score to one or more stakeholder-specific response directives based on stored policy rules;
VI. a ledger module configured to record event metadata, assessment outputs, response directives, and responder confirmations in a permissioned distributed ledger; and
VII. a user interface module accessible by authorized responders, the user interface module presenting the classification, severity score, and response directives and receiving responder feedback, wherein the system is configured to synchronize updates across multiple stakeholder interfaces in real time.

2. The system of claim 1, wherein the plurality of IoT sensor nodes comprise a combination of video sensors, audio sensors, accelerometers, environmental (temperature, humidity) sensors, or vibration sensors, and wherein each IoT sensor node performs edge preprocessing including feature extraction and noise filtering prior to transmission.

3. The system of claim 1, wherein the data gateway includes modules for cryptographic authentication of sensor nodes, timestamp normalization, geo-coordinate correlation, and deduplication of redundant sensor events.

4. The system of claim 1, wherein the trained machine-learning model comprises a fusion architecture combining convolutional neural network (CNN) layers for image data, transformer or attention layers for sequential telemetry data, and a probabilistic fusion layer to compute the severity score, and wherein the orchestration engine triggers a response directive when the confidence metric exceeds a predetermined threshold.

5. The system of claim 1, wherein the orchestration engine encodes response directives as smart contracts on the permissioned distributed ledger, automatically triggering allocation of resources or requests to responder units based on matching resource availability and proximity.

6. The system of claim 1, wherein the permissioned distributed ledger implements role-based access control, cryptographic permissions, and confidentiality partitions so that each stakeholder sees only approved event metadata and action logs.

7. The system of claim 1, wherein responder feedback submitted via the user interface module is recorded in the ledger module and used to retrain or adjust model weights in the AI assessment module using supervised learning.

8. The system of claim 1, wherein the system is organized as hierarchical sub-nodes (parent and child nodes) so that if a node or link fails, the system continues to operate via redundant routing, and parent nodes may override or reassign tasks to child nodes based on priority escalation.

9. A method for rapid assessment and collaborative response, comprising:
I. receiving sensor data from a plurality of IoT sensor nodes;
II. authenticating, correlating, and aggregating the sensor data at a data gateway;
III. analyzing the aggregated sensor data at a command server using a trained machine-learning model to produce an incident classification, a severity score, and a confidence metric;
IV. mapping, by an orchestration engine, the incident classification and severity score to one or more stakeholder-specific response directives according to stored policy rules;
V. publishing the classification, severity score, response directives, and responder confirmations to a permissioned distributed ledger;
VI. transmitting, to authorized responder interfaces, the classification, severity score, and response directives; and
VII. synchronizing updates across multiple stakeholder interfaces in real time based on responder feedback.

10. The method of claim 9, further comprising: performing edge preprocessing at the IoT sensor nodes including feature extraction and noise filtering before transmission to the gateway.

11. The method of claim 9, wherein the data gateway correlates sensor events by timestamp, location, and signal quality, and filters duplicate or redundant events.

12. The method of claim 9, wherein the orchestration engine issues response directives only if the confidence metric meets or exceeds a predefined threshold level.

13. The method of claim 9, further comprising encoding the response directives as smart contracts and automatically executing resource allocation or mutual-aid requests upon meeting contract conditions.

14. The method of claim 9, further comprising: capturing responder feedback, writing it to the ledger, and periodically retraining the machine-learning model using confirmed outcome data.

15. The method of claim 9, further comprising fallback routing of data through alternate nodes and reassigning tasks from disabled nodes to active nodes in the presence of failures, based on hierarchical node privilege policies.
